(19) United States
(12) Patent Application Publication
(10) Pub. No.: US 2008/0245681 A1
(43) Pub. Date: Oct. 9, 2008

(54) Toothbrush Holder with Integral Drain

(76) Inventor: Herbert M. Healis, South Yarmouth, MA (US)

Correspondence Address: ROBERT PLOTKIN, PC, 45 BUTTERNUT CIRCLE, CONCORD, MA, 01742-1937, US

(21) Appl. No.: 11/957,795

(22) Filed: Dec. 17, 2007

Related U.S. Application Data
(60) Provisional application No. 60/910,022, filed on Apr. 4, 2007.

(51) Int. Cl. B65D 81/00; F03B 11/02

(52) U.S. Cl. 206/209.1; 137/561 R

(57) ABSTRACT

A dental utensil or toothbrush holder has a container with a lid with a plurality of openings for accepting toothbrushes and other dental utensils such as dental picks. The toothbrush holder has an opening at the base allowing any fluids, such as that reside on the toothbrush after use, to drain from the container into a pipe. The pipe directs the fluid away from the container and to an indirect drain, a dental waste tee, connected to the building drain system.

### CROSS-REFERENCE TO RELATED APPLICATIONS

This application claims the benefit of U.S. Prov. Pat. App. Ser. No. 60/910,022, entitled, “Toothbrush Holder with Integral Drain,” filed on Apr. 4, 2007, hereby incorporated by reference herein.

### BACKGROUND

1. Field of the Invention

The present invention relates to a toothbrush or dental utensil holder and, more particularly, to a holder having a drain to facilitate draining of fluid away from the toothbrushes and dental utensils.

2. Related Art

Toothbrushes and other dental utensils are a perfect environment for the growth of germs and microorganisms. The toothbrush and the liquid that drains from it can carry disease or illnesses.

Conventional toothbrush holders allow the liquid to drain down the handle of the brush into the base of the container holding the brushes, where it accumulates, thereby creating an unsanitary condition. In the alternative, wall mounted holders hold the toothbrush above the counter. The liquid from the toothbrush drains onto the counter where it accumulates, thereby creating an unsanitary condition.

### SUMMARY

Unfortunately, there are deficiencies in conventional toothbrush holders in not moving the contaminated water away from the toothbrush. The water that drains from a previously-used toothbrush contains large amounts of bacteria and small particles of food debris. It is recognized that the fluid that collects is an environment for the growth of bacteria, fungus, and mold. In addition, the liquid can be a source of a foul odor.

In contrast to the above-described conventional toothbrush holders, embodiments of the holder disclosed herein drain the contaminated water away from the toothbrush and the holder. The toothbrush holder has a container with a lid with a plurality of openings for accepting toothbrushes and other dental utensils such as dental picks. The toothbrush holder has an opening at the base allowing any fluids, such as that reside on the toothbrush after use, to drain away from the container into a pipe. The pipe directs the fluid away from the container and to an indirect drain connected to the building drain system. Accordingly, the residue that drains from the toothbrush does not accumulate on the toothbrush or in the holder, such as in a conventional toothbrush holder with a solid base. The indirect drain is also referred to as a dental waste tee.

One embodiment of the present invention is a toothbrush holder for receiving at least one dental utensil having a handle and a head. The toothbrush holder has a housing defining an internal volume adapted to receive the handle of a dental utensil and a lid having a plurality of openings for receiving the handle of the dental utensil. The holder has an opening in the housing for directing fluid away from the housing.

The lid may, for example, have a concave shape and an opening in the nadir to allow fluid to drain from the lid into the housing. A pipe may be connected to the opening in the housing for directing fluid away from the housing. A screen may be carried in the internal volume of the housing.

In one embodiment, a lid for a toothbrush holder system has a base having a peripheral lip for engaging the housing. The base has a plurality of openings. Each opening is adapted to receive a dental utensil. The base has a concave shape with a nadir with an opening for draining fluids from the lid.

In one embodiment, a dental utensil holder system receives at least one dental utensil having a handle and a head. The holder system is adapted for use with a building drain system. The system has a holder including a housing and a lid. The housing defines an internal volume adapted to receive the handle of a dental utensil. The lid has a plurality of openings for receiving the handle of the dental utensil. The housing has an opening for directing fluid away from the internal volume of the housing.

In one embodiment, the holder has a pipe having a first end connected to the opening in the housing and a second end. The pipe directs fluid from the housing. The system has an indirect collector spaced from the second end of the pipe. The indirect collector is connected to the building drain system.

In one embodiment, the drain system has a drain line coupler connected to the building drain system. A line extends from the indirect collector to a drain line coupler for moving fluid from the indirect collector to the building drain system.

In one embodiment, the drain line coupler is rotatable relative to the building drain system, facilitating the locating of the holder relative to the building drain system. The line is telescoping, thereby facilitating the locating of the holder relative to the building drain system.

In one embodiment, the housing is formed integral with a counter.

In one embodiment, the housing is formed integrally with a sink unit. The holder has an opening for a drain. The dental utensil holder system has a line formed integrally with the sink unit. The line extends from the opening of the holder to the building drain system. An overflow opening extends from the basin in the sink unit to the drain line.

Other features and advantages of various aspects and embodiments of the present invention will become apparent from the following description and from the claims.

### BRIEF DESCRIPTION OF THE DRAWINGS

FIG. 1 is a sectional view of a toothbrush holder with a toothbrush shown in phantom according to one embodiment of the present invention;

FIG. 2 is a side sectional view of a sink arrangement with the toothbrush holder and drain pipe according to one embodiment of the present invention;

FIG. 3 is a top view of the toothbrush holder according to one embodiment of the present invention;

FIG. 4 is a sectional view of the drain line according to one embodiment of the present invention;

FIG. 5 is a side sectional view of an alternative arrangement of a sink arrangement with the toothbrush holder according to one embodiment of the present invention;

FIG. 6 is top view of the toothbrush holder of FIG. 5 according to one embodiment of the present invention;

FIG. 7 is a sectional view of an alternative arrangement of a sink with an integral toothbrush holder according to one embodiment of the present invention;

FIG. 8 is a sectional view of a portable toothbrush holder according to one embodiment of the present invention;

FIG. 9 is a sectional view of the portable toothbrush holder on a counter according to one embodiment of the present invention;

FIG. 10 is a sectional view of a toothbrush holder with a toothbrush shown in phantom according to one embodiment of the present invention;

FIG. 11A is a top view of an alternative toothbrush holder according to one embodiment of the present invention;

FIG. 11B is a sectional view of a toothbrush holder taken along the line 11B-11B of FIG. 11A with a toothbrush shown in phantom according to one embodiment of the present invention;

FIG. 12 is a side sectional view of a sink arrangement with the toothbrush holder and drain pipe according to one embodiment of the present invention;

FIG. 13A is a perspective view of a toothbrush holder according to one embodiment of the present invention; and

FIG. 13B is a top view of the toothbrush holder lid of FIG. 13A.

### DETAILED DESCRIPTION

A toothbrush holder has a container with a lid with a plurality of openings for accepting toothbrushes and other dental utensils such as dental picks. The toothbrush holder has an opening at the base allowing any fluids, such as that reside on the toothbrush after use, to drain from the container into a pipe. The pipe directs the fluid away from the container and to an indirect drain connected to the building drain system.

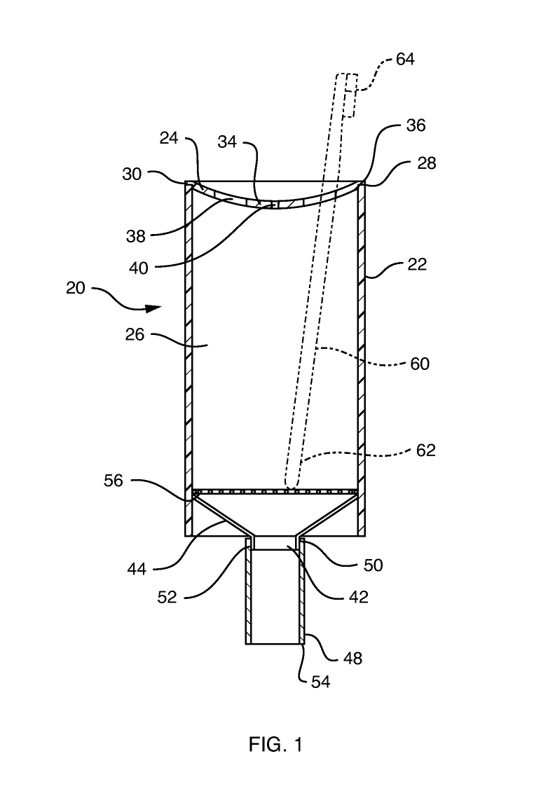

Referring to FIG. 1, a toothbrush holder 20 is shown. The toothbrush holder 20 has a housing 22 and a lid 24. The housing 22 defines an internal volume 26. The housing 22 has an upper edge 28 with a lip 30 that is adapted to receive the lid 24.

The lid 24 has a base 34 with a peripheral lip 36 for engaging the lip 30 of the housing 22. The lid 24 has a plurality of openings 38 for receiving dental utensils. The base 34 of the lid 24 has a concave shape. The nadir, the lowest point, of the base 34 has a hole 40 to allow fluid to drain into the internal volume 26 of the housing 22.

Still referring to FIG. 1, the housing 22 of the toothbrush holder 20 has an opening 42 to allow fluid that accumulates in the internal volume 26 to drain out. To facilitate draining of the internal volume 26, the housing has a conical bottom surface 44 to direct any fluid towards the opening 42.

The toothbrush holder 20 has a pipe 48 that has a first end 50 which is connected to a cylindrical wall 52 encircling the opening 42 at the bottom of the housing 22. The pipe directs any fluid that accumulates in the housing 22 away from the housing 22 and out of a second end 54 of the pipe 48.

Still referring to FIG. 1, a toothbrush 60 is shown in phantom. The toothbrush 60 has a handle 62 that extends through one of the openings 38 of the lid 24. The toothbrush 60 has a head 64, the portion that would be placed in the user's mouth. The head 64 is located above the lid 24 of the toothbrush holder 20. Any fluid on the toothbrush 60 that drains down from the head 64 to the handle 62 will enter the internal volume 26 of the housing 22.

In the arrangement shown, the toothbrush holder 20 has a mesh 56. The mesh 56 engages the housing 22 and is located in the lower portion of the internal volume 26. The mesh 56, in addition to the configuration of the openings 38 in the base 34 of the lid 24 prevents the toothbrush from falling into the opening 42 at the bottom of the housing 22.

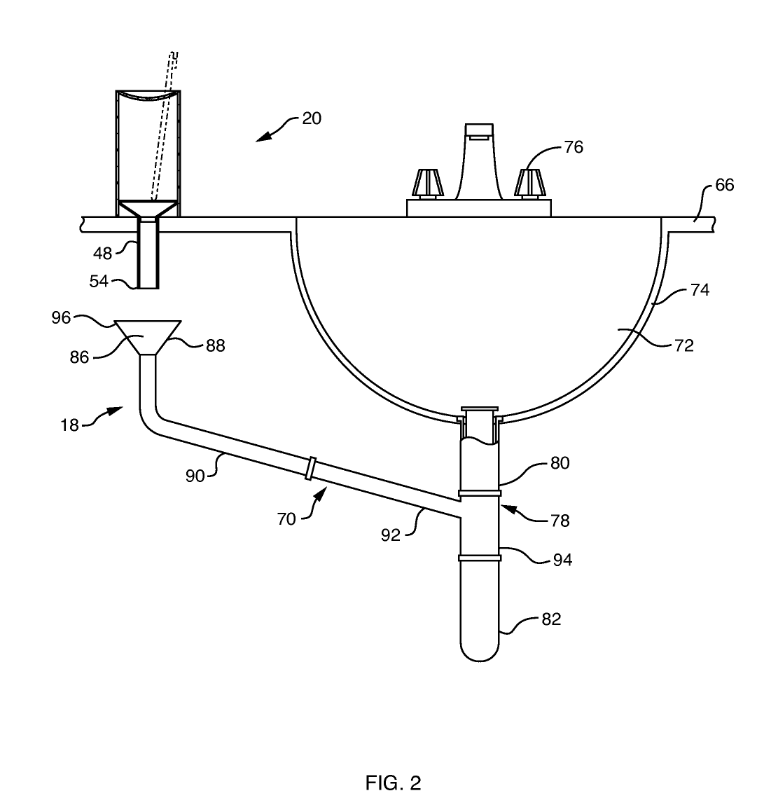

Referring to FIG. 2, a toothbrush holder system 18 on a counter 66, such as in a bathroom, is shown. The toothbrush or dental utensil holder system 18 has the toothbrush holder 20 and a drain system 70.

A conventional sink 72 has a basin 74 to hold water, a faucet 76 for adding water, and a drain line 78. The drain line 78 is connected directly to the basin 74. A pipe 80 of the drain line extends from the basin 74 to a trap 82 to prevent sewer gases from entering the building.

Still referring to FIG. 2, the drain system 70 of the dental utensil holder system 18 has an indirect collector or dental waste tee 86 spaced from the pipe 48 of the toothbrush holder 20. The indirect collector 86 has a conical-shaped funnel 88 that opens into a first drain line 90. The drain line 90 in the arrangement shown is slideably received in a second drain line 92. The second drain line 92 has a tee 94 wherein the drain system 70 joins the pipe 80 extending from the basin 74 of the sink 72.

One advantage of the dental utensil holder system 18 is the leveraging of the existing building drainage system. The system 18 does not require additional piping in the walls of the building to integrate the system 18.

The indirect collector 86 is spaced from the second end 54 of the pipe 48 of the toothbrush holder 20 to prevent the possibility of drain line back-up from reaching the dental utensils in the toothbrush holder 20. In the event that the drain system of the building backs up, the sewage would flow over the edge 96 of the funnel 88 of the indirect collector 86 and not pass into the toothbrush holder 20.

It is recognized that the possibility of such a back-up depends predominately on the drain lines 78 of the building. Whether such a back-up will occur further depends on the layout of the sink 72, in that the top of the sink 72 is below the lowest position where the handle 62 of the toothbrush 60 or dental utensil would be located, such that any back up would likely fill the sink.

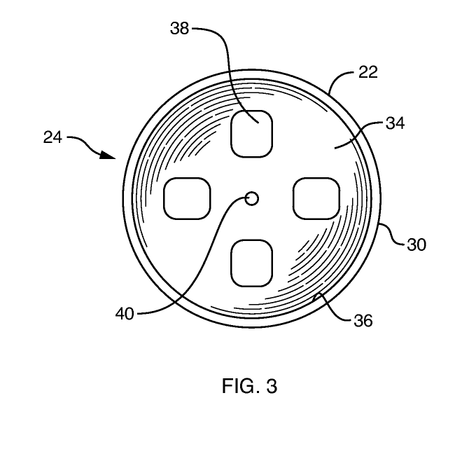

Referring to FIG. 3, a top view of the housing 22 and lid 24 of the toothbrush holder 20 is shown. In the arrangement shown, the lid 24 has a circular shape. The lip 36 of the lid 24 is accepted by the lip 30 of the housing 22. The base 34 of the lid 24 has a concave shape with a hole 40 in the center. The lid 24 shown has four openings 38, each opening sized to receive a handle 62 of a toothbrush 60, shown in phantom in FIG. 1, or other dental utensil such as a dental pick, inter-dental, etc.

While the housing 22 is shown having a circular opening and the lid 24 is sized to fit the opening, it is recognized that the toothbrush holder 20 could have a different shape such as generally square or rectangular.

It is recognized that in certain situations, such as institutions or hospitals, the lid 24 could be replaced when a new person moves into the room associated with the toothbrush holder.

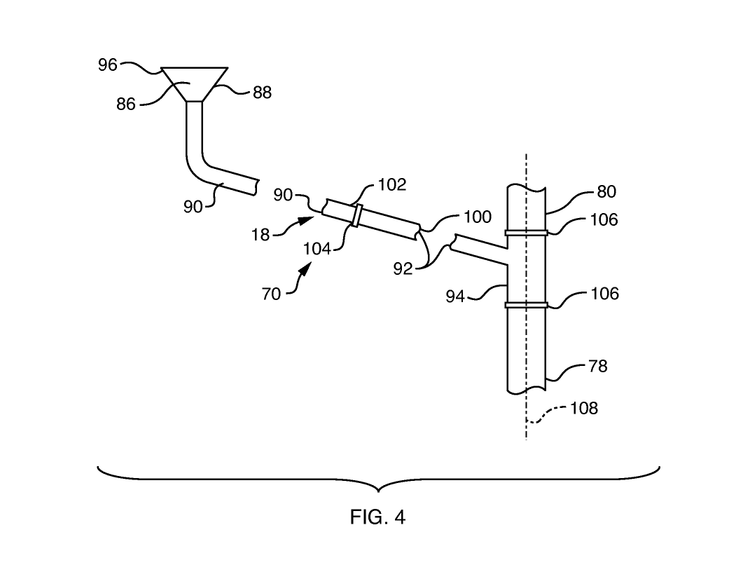

Referring to FIG. 4, a sectional view of three portions of the drain system 70 of the dental utensil holder system 18 is shown. The indirect collector 86 includes the conical-shaped funnel 88, which opens into the first drain line 90, as shown in the section on the left side of FIG. 4. The center section of FIG. 4 shows the first drain line 90 slideably received in the second drain line 92. The second drain line 92 has an inner diameter 100 capable of receiving the outer diameter 102 of the first drain line 90. In the arrangement shown, the drain system 70 has a coupling 104 for tightening the two drain lines 90 and 92 relative to each other after the indirect collector 86 is positioned under the pipe 48 projecting from the bottom of the housing 22 of the toothbrush holder 20, such as seen in FIG. 2.

Still referring to FIG. 4, the second drain line 92 of the drain system 70 has the tee 94. The tee 94 joins the second drain line 92 of the drain system 70 to the building drain line 78. The pipe 80 from the sink 72 is shortened and the tee 94 is interposed between the pipe 80 and the trap 82. The tee 94 is shown with a pair of couplings 106 for securing the tee 94 to the pipe 80 and the trap 82, respectively. The tee 94 may be rotated about the drain line 78 axis, as represented by the center line 108 so that the second drain line 92 is extending out in the proper orientation so that the indirect collector 86 of the drain system 70 is positioned under the pipe 48 of the toothbrush holder 20. The couplings 106 are tightened after the drain system 70 is positioned.

The pipe 80 may be shortened in various methods depending on the type of pipe. For example, the pipe 80 may be cut if it is made of PVC or the pipe may be replaced with a shorter pipe to fit the length.

The toothbrush holder 20 of the toothbrush holder system 18 may be cleaned as part of cleaning of the room. The lid 24 may be removed from the housing 22. In addition the mesh 56 may be removed from the housing 22. Both the lid 24 and the mesh 56 may be cleaned in various ways including placing in the dishwasher. The walls of the housing 22 and the pipe 48 may be scrubbed with a brush.

Among the advantages of the embodiment described above and embodiments below is the potential improved sanitation of the dental utensils including toothbrushes. The water and food debris located on the toothbrush that drains and falls off, falls into the internal volume and is moved away.

Another advantage is that the countertop and associated caulk and grout will not be exposed to the liquid draining from the toothbrush. Therefore the countertop will be less susceptible to mold and mildew. It follows that the countertop will maintain an aesthetically pleasing appearance and last longer if cleaned properly.

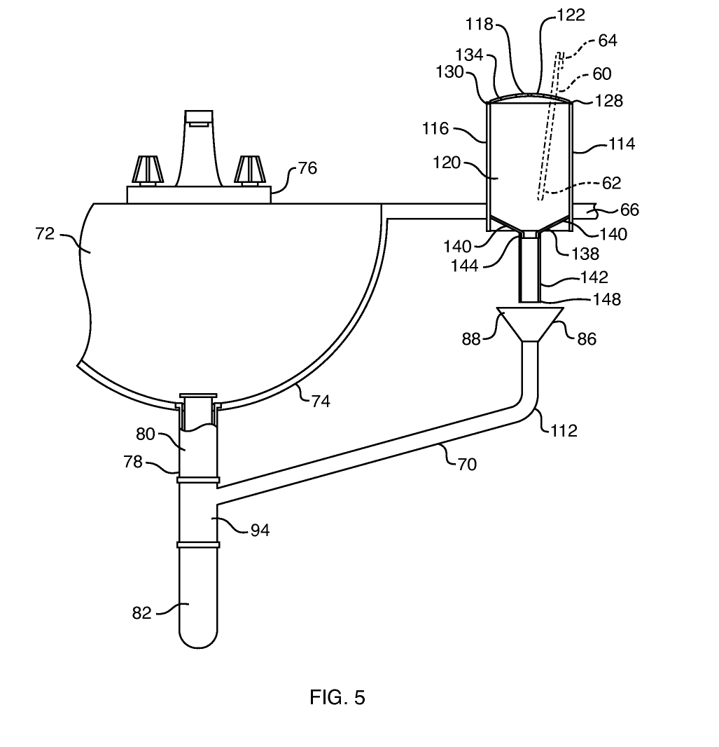

Referring to FIG. 5, an alternative toothbrush holder system 112 with a toothbrush holder 114 is formed integral with the counter 66, such as in a bathroom is shown. The toothbrush or dental utensil holder system 112 includes the toothbrush holder 114 and a drain system 70.

The conventional sink 72 has a basin 74 to hold water, a faucet 76 for adding water, and a drain line 78. The drain line 78 is connected directly to the basin 74. A pipe 80 of the drain line extends from the basin 74 to a trap 82 to prevent sewer gases from entering the building.

The toothbrush holder 114 has a housing 116 and a lid 118. The housing 116 is formed integrally with the counter 66. The housing 116 defines an internal volume 120. Similar to the arrangement shown in FIG. 1, the housing 116 has an upper edge 128 with a lip 130 that is adapted to receive the lid 118. The lid 118 has a base 122 with a peripheral lip 132 for engaging the lip 130 of the housing 116. The lid 118 has a plurality of openings 134 for receiving dental utensils.

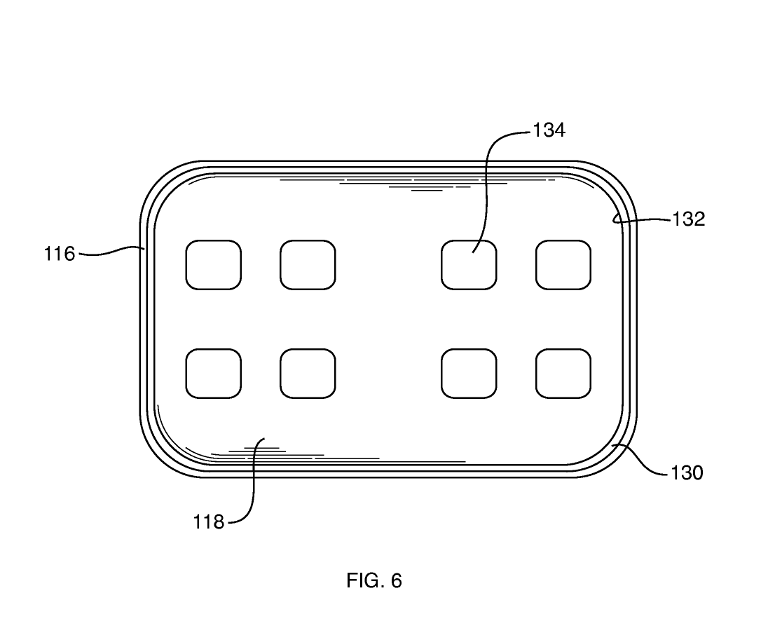

In contrast to the lid of FIGS. 1 and 3, the base 122 of the lid 118 has a generally convex shape. As best seen in FIG. 6, the lid 118 has generally a rectangular shape. The base 122 of the lid 118 has eight (8) openings 134 for receiving dental utensils.

Referring back to FIG. 5, the housing 116 of the toothbrush holder 114 has an opening 138 to allow fluid that accumulates in the internal volume 120 to drain out. To facilitate draining of the internal volume 120, the housing 116 has an angled bottom surface 140 to direct any fluid towards the opening 138.

The toothbrush holder 114 has a pipe 142 that has a first end 144 which is connected to a cylindrical wall 146 encircling the opening 138 at the bottom of the housing 116. The pipe 142 directs any fluid that accumulates in the housing 116 away from the housing 116 and out of a second end 148 of the pipe 142.

Still referring to FIG. 5, the toothbrush 60 is shown in phantom. The toothbrush 60 includes the handle 62, which extends through one of the openings 134 of the lid 118. The toothbrush 60 includes the head 64 (the portion that would be placed in the user's mouth). The head 64 is located above the lid 118 of the toothbrush holder 114. Any fluid on the toothbrush 60 that drains down from the head 64 to the handle 62 will enter the internal volume 120 of the housing 116.

In the arrangement shown, in contrast to that of FIG. 1, the toothbrush holder 114 does not have a mesh for supporting the toothbrush 60. The toothbrush 60 is either supported by the handle 62 of the toothbrush 60 engaging the bottom surface 140 or the head 64 of the toothbrush 60 engaging the base 122 of the lid 118.

Still referring to FIG. 5, the drain system 70 of the dental utensil holder system 112 has an indirect collector 86 spaced from the pipe 142 of the toothbrush holder 114. The indirect collector 86 has a conical-shaped funnel 88 that opens into a first drain line 90. The drain line 90 in the arrangement shown is slideably received in a second drain line 92 having an interior diameter capable of receiving the outer diameter of the first drain line 90. The second drain line 92 has a tee 94 wherein the drain system 70 joins the pipe 80 extending from the basin 74 of the sink 72.

The purpose of the indirect collector 86 being spaced from the second end 148 of the pipe 142 of the toothbrush holder 20 is to prevent the possibility of drain line back-up from reaching the dental utensils in the toothbrush holder 114. In the possibility of the drain system of the building backing up, the sewage would flow over the edge 96 of the funnel 88 of the indirect collector 86 and not pass into the toothbrush holder 114.

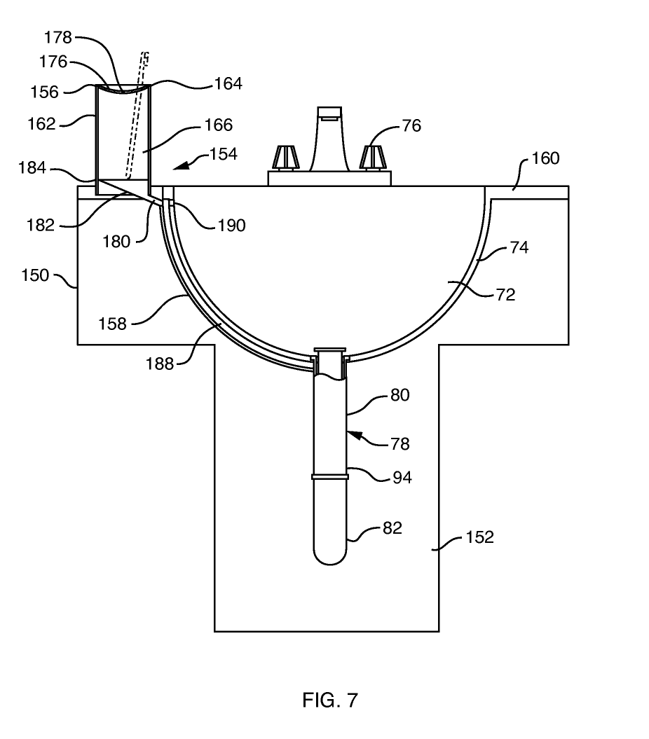

Referring to FIG. 7, a pedestal sink 150 with a toothbrush holder system 154 is shown. The pedestal sink 150 has a basin 74 with a faucet 76 and a drain line 78. In contrast to the previous embodiments, the drain line 78 is hidden behind a pedestal 152 shown in phantom, rather under a counter in a cabinet. With the narrow pedestal 152, the drain system 70 of the embodiment shown in FIGS. 2 and 5 would likely be seen by the user of the pedestal sink 150.

The toothbrush holder system 154 has both a toothbrush holder 156 and a drain system 158 formed integrally with the basin 74 of the pedestal sink 150. The toothbrush holder 156 is formed integrally with the ledge 160 of the pedestal sink 150.

The toothbrush holder 156 has a housing 162 and a lid 164. The housing 162 is formed integrally with the ledge 160. The housing 162 defines an internal volume 166. Similar to the arrangement shown in FIG. 1, the housing 162 has an upper edge with a lip that is adapted to receive the lid 164. The lid 164 has a base with a peripheral lip for engaging the lip of the housing 162. The lid 164 has a plurality of openings 176 for receiving dental utensils.

The base of the lid 164 has a concave shape. The nadir, the lowest point, of the base has a hole 178 to allow fluid to drain into the internal volume 166 of the housing 162.

The housing 162 of the toothbrush holder 156 has an opening 180 to allow fluid that accumulates in the internal volume 166 to drain out. To facilitate draining of the internal volume 166, the housing 162 has an angled bottom surface 182 to direct any fluid towards the opening 180.

In the arrangement shown, the toothbrush holder 156 has a mesh 184. The mesh 184 engages the housing 162 and is located in the lower portion of the internal volume 166. The mesh 184, in addition to the configuration of the openings 176 in the base of the lid 164, prevents the toothbrush from falling into the opening 180 at the bottom of the housing 162.

In contrast to the arrangements discussed above, the opening 180 at the bottom of the angled bottom surface 182 of the housing 162 is connected to a line 188 formed integral with the basin 74 of the pedestal sink 150. The line 188 extends down from the housing 162 to the drain line 78, which is located behind the pedestal 152, which is shown in phantom. The line 188 forms the drain system 158 of the toothbrush holder system 154. The drain system 158 has at least one opening 190 into the basin 74 near the top of the basin 74. The opening 190 acts similar to other overflow holes to drain liquid out of the basin 74 to prevent overflow.

In addition, the opening 190 acts as an outlet if the drain line back ups and therefore prevents any back up from reaching the dental utensils in the toothbrush holder 156. Likewise, in the arrangement shown, the top of the basin 74 of the pedestal sink 150 shown is below the lowest position where the handle 62 of the toothbrush 60 or dental utensil would be located.

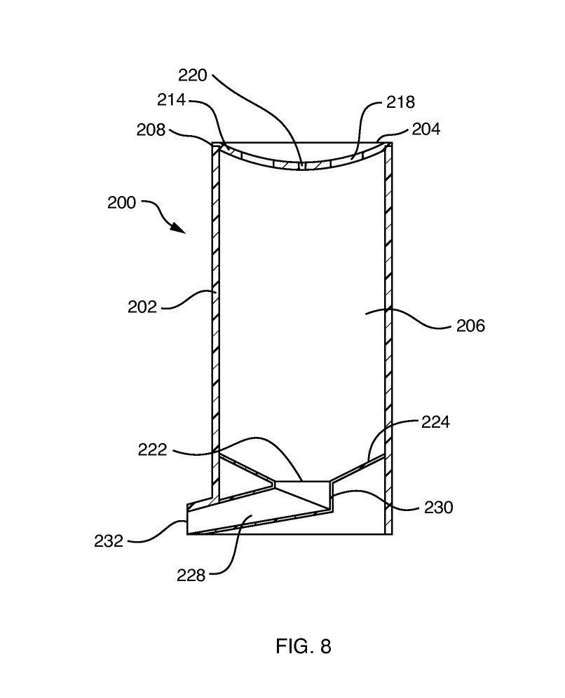

Referring to FIG. 8, a portable toothbrush holder 200 is shown. The toothbrush holder 200 has a housing 202 and a lid 204. The housing 202 defines an internal volume 206.

Similar to the arrangements shown in FIG. 1, the housing 202 has an upper edge 208 with a lip that is adapted to receive the lid 204. The lid 204 has a base 214 with a peripheral lip for engaging the lip of the housing 202.

The lid 204 has a plurality of openings 218 for receiving dental utensils. The base 214 of the lid 204 has a concave shape. The nadir of the base 214 has a hole 220 to allow fluid to drain into the internal volume 206 of the housing 202.

Still referring to FIG. 8, the housing 202 of the toothbrush holder 200 has an opening 222 to allow fluid that accumulates in the internal volume 206 to drain out. To facilitate draining of the internal volume 206, the housing 202 has a conical bottom surface 224 to direct any fluid towards the opening 222.

The toothbrush holder 200 has a channel 228 that extends from a cylindrical wall 230 encircling the opening 222 at the bottom of the internal volume 206. The channel 228 extends to an opening 232 to direct any fluid that accumulates in the housing 202.

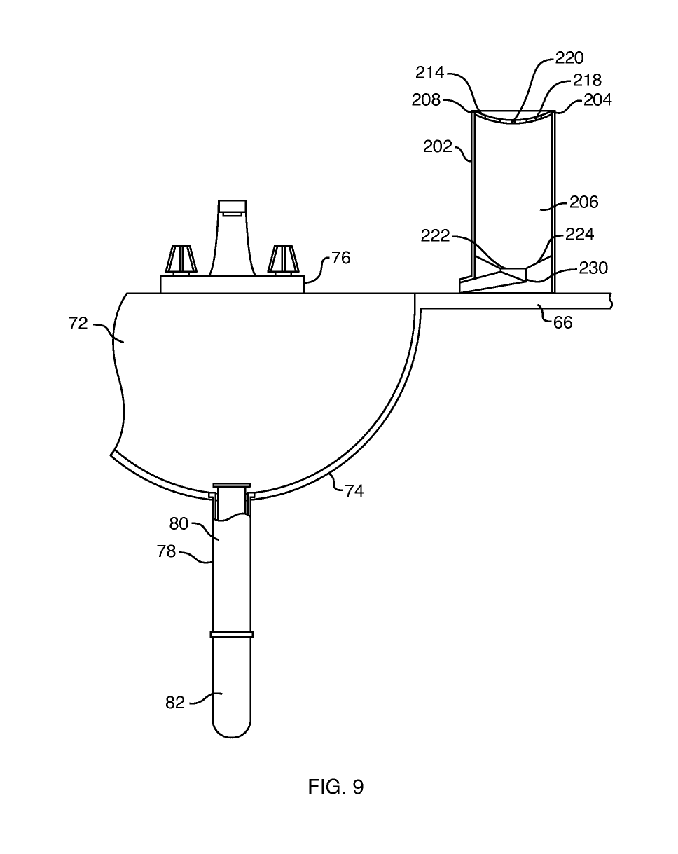

Referring to FIG. 9, the portable toothbrush holder 200 is shown on a counter 66, such as in a bathroom. The conventional sink 72 includes a basin 74 to hold water, a faucet 76 for adding water, and a drain line 78. The drain line 78 is connected directly to the basin 74. The pipe 80 of the drain line extends from the basin 74 to a trap 82 to prevent sewer gases from entering the building.

The portable toothbrush holder 200 is placed adjacent to the basin 74 of the sink. Any liquid that accumulates in the internal volume 206 drains out through the opening into the channel and out through the opening 222 into the sink basin 74 and not onto the counter 66.

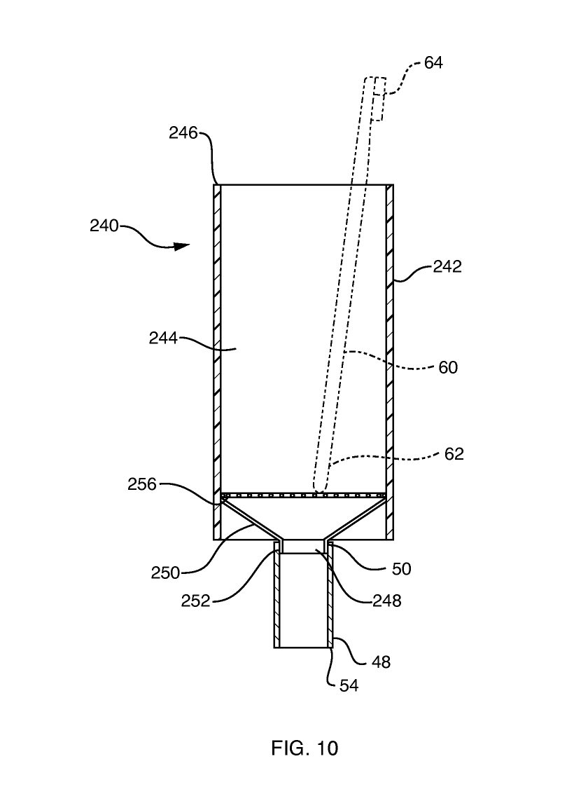

Referring to FIG. 10, a toothbrush holder 240 is shown. The toothbrush holder 240 has a housing 242 but no lid. The housing 242 defines an internal volume 244. The housing 242 has an upper edge or rim 246.

The housing 242 of the toothbrush holder 240 has an opening 248 to allow fluid that accumulates in the internal volume 244 to drain out. To facilitate draining of the internal volume 244, the housing has a bottom surface 250 to direct any fluid towards the opening 248.

The toothbrush holder 240 has a pipe 48 that has a first end 50 which is connected to a cylindrical wall 252 encircling the opening 248 at the bottom of the housing 242. The pipe 48 directs any fluid that accumulates in the housing 242 away from the housing 242 and out of a second end 54 of the pipe 48.

Still referring to FIG. 10, a toothbrush 60 is shown in phantom. The toothbrush 60 has a handle 62 that can lean against the rim 246 of the housing 242. The toothbrush 60 has a head 64, the portion that would be placed in the user's mouth. The head 64 is located above the top, the rim 246 of the toothbrush holder 240. Any fluid on the toothbrush 60 that drains down from the head 64 to the handle 62 will enter the internal volume 244 of the housing 242.

In the arrangement shown, the toothbrush holder 240 has a mesh 256. The mesh 256 engages the housing 242 and is located in the lower portion of the internal volume 244. The mesh 256 prevents the toothbrush from falling into the opening 248 at the bottom of the housing 242.

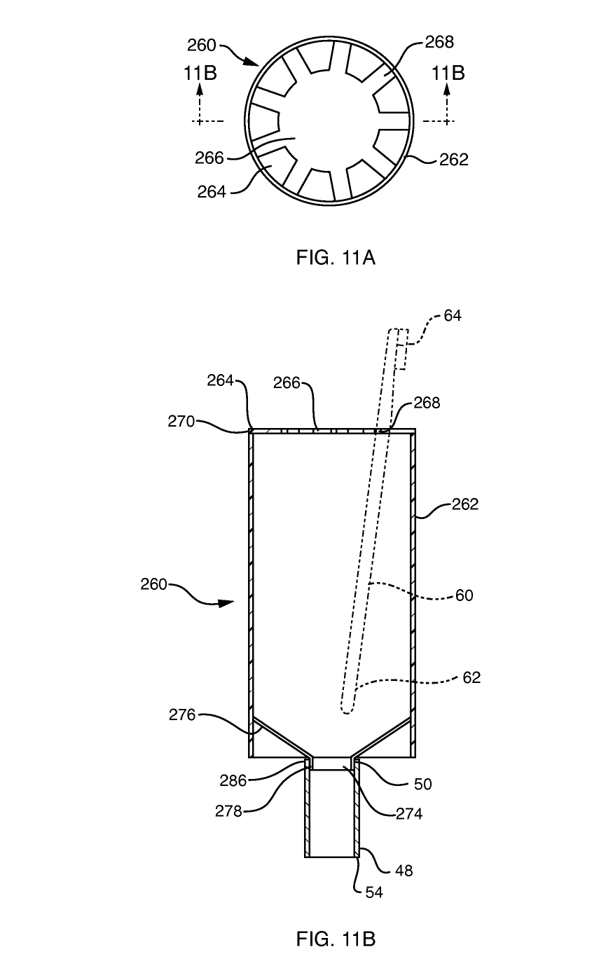

Referring to FIG. 11A, a top view of a housing 262 of a toothbrush holder 260 is shown. In the arrangement shown, the housing 262 has an annular ring 264. The annular ring 264 has a central opening 266 and a plurality of slots 268. Each of the slots 268 can accept a dental utensil.

Referring to FIG. 11B, a sectional view of the toothbrush holder 260 is shown. The toothbrush holder 260 has the housing 262 with an upper edge 270. The annular ring 264 projects inward and defines the central opening 266 to access an internal volume 272. The annular ring 264 acts as a partial lid and has the plurality of slots 268.

The housing 262 of the toothbrush holder 260 has an opening 274 to allow fluid that accumulates in the internal volume 272 to drain out. To facilitate draining of the internal volume 272, the housing 262 has a bottom surface 276 to direct any fluid towards the opening 274.

The toothbrush holder 260 has a pipe 48 that has a first end 50 which is connected to a cylindrical wall 278 encircling the opening 274 at the bottom of the housing 262. The pipe directs any fluid that accumulates in the housing 262 away from the housing 262 and out of a second end 54 of the pipe 48.

A toothbrush 60 is shown in phantom. The toothbrush 60 has a handle 62 that extends through one of the openings 38 of the lid 24. The toothbrush 60 has a head 64, the portion that would be placed in the user's mouth. The head 64 is located above the annular ring 264 of the toothbrush holder 260. Any fluid on the toothbrush 60 that drains down from the head 64 to the handle 62 will enter the internal volume 272 of the housing 262.

In the arrangement shown, the toothbrush holder 260 has a mesh 286. The mesh 286 engages the cylindrical wall 278 and is located in the lower portion of the internal volume 26. The mesh 286, in addition to the configuration of the slots 268 in the annular ring 264 prevents the toothbrush from falling into the opening 274 at the bottom of the housing 262.

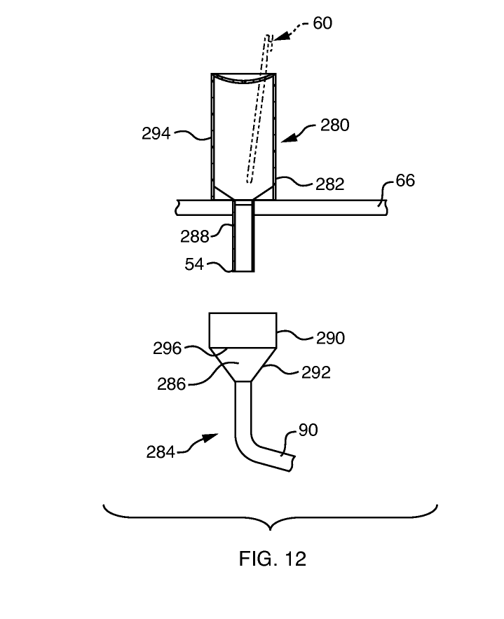

Referring to FIG. 12, an alternative toothbrush holder system 280 on a counter 66, such as in a bathroom, is shown. The toothbrush or dental utensil holder system 280 has the toothbrush holder 282 and a drain system 284.

The drain system 280 of the dental utensil holder system 280 has an indirect collector 286 spaced from a pipe 288 of the toothbrush holder 282. The indirect collector 286 has a cylindrical portion 290 and a conical-shaped funnel 292 that opens into a first drain line 90. The drain line 90 can be slideably received in a second drain line 92 as shown in FIG. 2.

The indirect collector 286 is spaced from the second end 54 of the pipe 288 of the toothbrush holder 282 to prevent the possibility of drain line back-up from reaching the dental utensils in the toothbrush holder 282.

The toothbrush 60 is shown in phantom. The toothbrush 60 has a handle that extends through one of the openings 38 of the lid 24. The toothbrush 60 has a head, the portion that would be placed in the user's mouth. The head is located above the lid 24 of the toothbrush holder 20. Any fluid on the toothbrush 60 that drains down from the head to the handle will enter the internal volume 26 of the housing 294.

In the arrangement shown, the indirect collector 286 has a mesh 296 such as a screen or a rack. The mesh 296 is at the cylindrical portion 290 and the conical-shaped funnel 292. The mesh 296 prevents items such as a toothbrush from falling into the drain system 284.

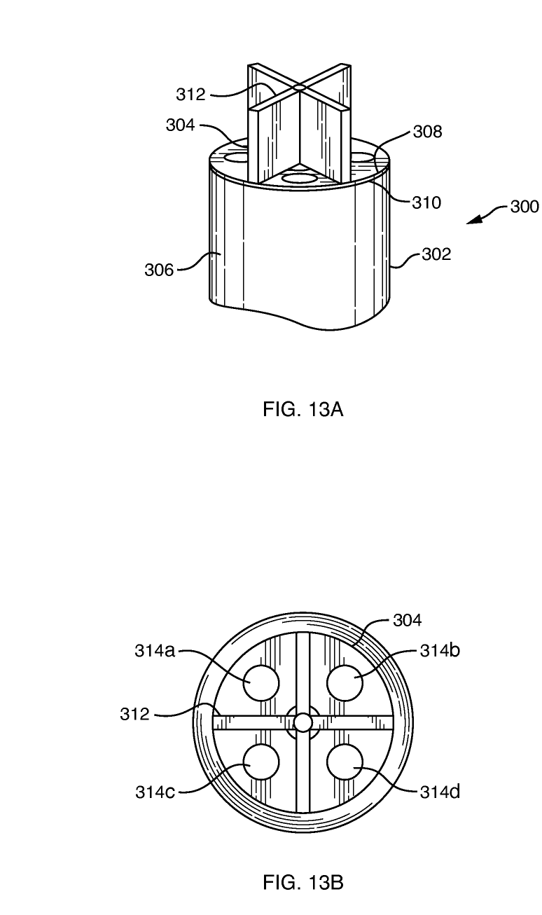

Referring to FIG. 13A, a perspective view of a toothbrush holder 300 is shown. The toothbrush holder 300 may, for example, have features similar to those of the toothbrush holder 20 shown in FIG. 1, or of other toothbrush holders disclosed herein. The toothbrush holder 300 has a housing 302 and a lid 304. The housing 302 defines an internal volume 306. The housing 302 has an upper edge 308 with a lip 310 that is adapted to receive the lid 304.

As further shown in the top view of FIG. 13B, the lid 304 also includes a divider 312, which separates openings 314a-d, thereby preventing toothbrushes inserted into the openings 314a-d from coming into contact with each other. The divider 312, which may be molded in one piece with the remainder of the lid 304 or otherwise affixed to the remainder of the lid 304, may also act as a handle to enable the lid 304 to be removed from the holder 300 and placed back onto the holder 300 easily.

Referring to FIG. 3, a top view of the housing 22 and lid 24 of the toothbrush holder 20 is shown. In the arrangement shown, the lid 24 has a circular shape. The lip 36 of the lid 24 is accepted by the lip 30 of the housing 22. The base 34 of the lid 24 has a concave shape with a hole 40 in the center. The lid 24 shown has four openings 38, each opening sized to receive a handle 62 of a toothbrush 60, shown in phantom in FIG. 1, or other dental utensil such as a dental pick, inter-dental, etc.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further divided into additional components or joined together to form fewer components for performing the same functions.

It is recognized that the mesh described could be a rack, a screen, or other device that prevents a dental utensil from falling into the drain line.

What is claimed is:

1. A dental utensil holder for receiving a dental utensil having a handle and a head, the dental utensil holder comprising:
a housing defining an internal volume adapted to receive the handle of the dental utensil; and
an opening in the housing for directing fluid away from the housing.

2. The dental utensil holder of claim 1, wherein the dental utensil comprises a toothbrush.

3. The dental utensil holder of claim 1, further comprising:
a lid having an opening to receive the handle of the dental utensil.

4. The dental utensil holder of claim 1, wherein the lid further comprises:
a plurality of openings adapted to receive a plurality of dental utensils; and
a divider separating each one of the plurality of openings from the other ones of the plurality of openings.

5. The dental utensil holder of claim 1, wherein the lid has a plurality of openings to receive a plurality of handles of a plurality of dental utensils.

6. The dental utensil holder of claim 3, wherein the lid has a concave shape having a nadir, and wherein the lid has an opening in the nadir to allow fluid to drain from the lid into the housing.

7. The dental utensil holder of claim 3, further comprising a pipe connected to the opening in the housing for directing fluid away from the housing.

8. The dental utensil holder of claim 3, further comprising a screen carried in the internal volume of the housing.

9. The dental utensil holder of claim 3, further comprising a rack carried in the internal volume of the housing.

10. A lid for a dental utensil holder system having a housing, the lid comprising:
a base having a peripheral lip for engaging the housing;
the base having a plurality of openings adapted to receive a plurality of dental utensils;
the base having a concave shape with a nadir with an opening for draining fluids from the lid.

11. A dental utensil holder system for receiving a dental utensil, the dental utensil having a handle and a head, the holder system adapted for use with a building drain system, the dental utensil holder system comprising:
a holder including
a housing defining an internal volume adapted to receive the handle of the dental utensil;
a lid having an opening to receive the handle of the dental utensil; and
an opening in the housing.

12. The dental utensil holder system of claim 11, wherein the holder further comprises a pipe having a first end connected to the opening in the housing and a second end, the pipe for directing fluid from the housing and the system further comprising a drain system having an indirect collector spaced from the second end of the pipe, the indirect collector connected to the building drain system.

13. The dental utensil holder system of claim 12, wherein the drain system further comprises:
a drain line coupler connected to the building drain system; and
a line extending from the indirect collector to a drain line coupler for moving fluid from the indirect collector to the building drain system.

14. The dental utensil holder system of claim 13, wherein the drain line coupler is rotatable relative to the building drain system, thereby facilitating the locating of the holder relative to the building drain system.

15. The dental utensil holder system of claim 13, wherein the line is telescoping, thereby facilitating the locating of the holder relative to the building drain system.

16. The dental utensil holder system of claim 11, wherein the housing is formed integrally with a sink unit, the holder having an opening for a drain, the dental utensil holder system having a line formed integrally with the sink unit, the line extending from the opening of the holder to the building drain system.

17. The dental utensil holder system of claim 16, wherein the dental utensil holder system has an overflow opening extending from the basin in the sink unit to the line.

18. The dental utensil holder system of claim 11, wherein the housing further comprises a pipe connected to the opening in the housing for directing fluid away from the housing.

19. The dental utensil holder system of claim 18, further comprising a screen carried in the internal volume of the housing.

20. The dental utensil holder system of claim 19, wherein the lid has a concave shape having a nadir, and wherein the lid has an opening in the nadir to allow fluid to drain from the lid into the housing and into the drain pipe.

21. A dental utensil holder for receiving a dental utensil having a handle and a head, the dental utensil holder comprising:
a housing defining an internal volume adapted to receive the handle of the dental utensil;
an opening in the housing; and
a drain line connected to the opening in the housing for directing fluid away from the housing.

22. The dental utensil holder of claim 21, further comprising a lid received by the housing, the lid having an opening to receive the handle of the dental utensil.

23. The dental utensil holder of claim 22, wherein the lid has a concave shape having a nadir, and wherein the lid has an opening in the nadir to allow fluid to drain from the lid into the housing.

24. The dental utensil holder system of claim 11, further comprising a screen carried by the indirect collector.

25. The dental utensil holder system of claim 11, further comprising a rack carried by the indirect collector.
